(19) United States
(12) Patent Application Publication
(10) Pub. No.: US 2018/0079032 A1
(43) Pub. Date: Mar. 22, 2018

(54) LASER WELDING METHOD AND LASER WELDING DEVICE

(71) Applicant: HONDA MOTOR CO., LTD., Tokyo (JP)

(72) Inventor: Shigeo Yajima, Tochigi (JP)

(21) Appl. No.: 15/661,522

(22) Filed: Jul. 27, 2017

(30) Foreign Application Priority Data
Sep. 16, 2016 (JP) 2016-181690

(51) Int. Cl. B23K 26/32; B23K 26/70; B23K 31/12

(52) U.S. Cl. CPC B23K 26/32; B23K 31/125; B23K 26/705

(57) ABSTRACT

The laser welding method includes: a step of applying, with a laser head, a laser to a joint part of electrical conductors serving as metal members to be welded and detecting, with an infrared sensor, reflected light of the laser from the joint part or detecting, with a visible light sensor, light emitted from metal vapor; and a step of comparing the detection values of the infrared sensor and the visible light sensor and setting values respectively so as to determine whether or not energy absorption is started in the electrical conductors and adjusting the control of the application of the laser based on timing at which the energy absorption is determined to be started.

This application is based on and claims the benefit of priority from Japanese Patent Application No. 2016-181690, filed on 16 Sep. 2016, the content of which is incorporated herein by reference.

### BACKGROUND OF THE INVENTION

### Field of the Invention

The present invention relates to a laser welding method and a laser welding device with which a metal member is joined by laser welding.

### Related Art

Conventionally, a technology is known in which a metal member is joined by laser welding. An example of a document which discloses this type of technology is patent document 1. Patent document 1 discloses a method of manufacturing a rotary electric machine by joining, through laser welding, tip end portions of a plurality of electrical conductors one another which are inserted through individual slots provided in a stator core and which are protruded from the slots. It is known that copper used as this type of electrical conductor has a low laser absorption rate, and in order to shorten a time necessary for the absorption of a laser, a large capacity laser transmitter is used, and in order to enhance the laser absorption rate, preprocessing or the like such as oxidizing its surface is performed.

Patent Document 1: Japanese Unexamined Patent Application, Publication No. 2014-230295

### SUMMARY OF THE INVENTION

FIGS. 4A to 4D are timing charts showing a relationship between a laser application time and an energy absorption time which are conventional. FIGS. 4A, 4B, 4C and 4D show laser energy absorption times which are different depending on individual metal members to which a laser is applied. As shown in FIGS. 4A to 4D, in a case where laser welding is managed by time, even when the laser application time is the same, due to variations in the surface shape, the surface state and the like of the metal members, laser energy absorption times (absorption start timing) are varied for each of works (metal members), with the result that the molten state may not be stabilized. The use of a large capacity laser transmitter or preprocessing or the like such as for oxidizing the surface of a work causes increases in cost and cycle time. In the conventional laser welding technology, there is room for improvement in terms of the stability of quality and efficiency.

The present invention has an object to provide a laser welding method and a laser welding device which can stably and efficiently supply a high-quality product by reducing a variation in laser energy absorption time.

The present invention relates to a laser welding method of joining metal members (for example, electrical conductors 40 which will be described later) by laser welding, the laser welding method including: a step of applying, with a laser application portion (for example, a laser head 11 which will be described later), a laser to a joint part of the metal members to be welded and detecting, with a light detection portion (for example, an infrared sensor 12 or a visible light sensor 13 which will be described later), the light of the joint part produced by the application of the laser; and a step of comparing a detection value of the light detection portion and a setting value so as to determine whether or not energy absorption is started in the metal members and adjusting the control of the application of the laser based on timing at which the energy absorption is determined to be started.

In this way, the light of the joint part is detected, and thus by the utilization of the characteristic in which when the metal members absorb laser, the metal members are changed from a reflection member to an absorption member, it is possible to accurately determine timing at which the absorption of the energy of the laser is started in the metal members. The timing at which the absorption of the energy of the laser is started in the metal members is reflected on the control of the application, and thus the molten state which is varied depending on the metal members to be welded can be made uniform. For example, even when the metal members such as copper whose reflectance is high are the target to be welded, since it is possible to acquire a sufficient laser energy absorption time necessary for the metal members, it is possible to stably perform a welding operation with a small capacity laser oscillator without use of a large capacity laser oscillator and performing oxidization processing on the surface of the electrical conductors, with the result that it is possible to reduce the cost and the cycle time.

The light detection portion (for example, an infrared sensor 12 which will be described later) preferably detects the reflected light of the laser.

In this way, by the utilization of variations in the reflected light of the laser, it is possible to accurately determine the timing at which energy absorption is started.

The light detection portion (for example, a visible light sensor 13 which will be described later) preferably detects visible light emitted from vapor of the metal members produced by the application of the laser.

In this way, by the utilization of the visible light from the plume (metal vapor) in which the produced amount is increased as the absorption of the proceeds, it is possible to accurately determine timing at which energy absorption is started.

Preferably, in the step of adjusting the control of the application of the laser, the application of the laser is continued until a predetermined time has elapsed since energy absorption is determined to be started in the metal members, and the application of the laser is completed after the predetermined time has elapsed.

In this way, it is possible to reduce variations in energy absorbed in the metal members, and thus it is possible to realize control for stabilizing the molten state with the simple processing for adjusting the application time.

The present invention also relates to a laser welding device including: a laser application portion (for example, the laser head 11 which will be described later) which applies the laser to metal members (for example, the electrical conductors 40 which will be described later) to be welded; a reflected light detection portion (for example, the infrared sensor 12 which will be described later) which detects reflected light of the laser applied from the laser application portion to the metal members; and a control portion (for example, a laser control unit 20 which will be described later) which performs control of the application of the laser, where the control portion includes: a determination portion (for example, a determination portion 21 which will be described later) which compares a detection value of the reflected light detection portion and a setting value so as to determine whether or not energy absorption is started in the metal members; and an application control portion (for example, an application control portion 22 which will be described later) which adjusts the control of the application of the laser based on timing at which the absorption of the energy is determined to be started.

In this way, the reflected light of the laser is detected, and thus by the utilization of the characteristic in which, when the metal members absorb the laser, the metal members are changed from a reflection member to an absorption member, it is possible to accurately determine timing at which laser energy absorption is started in the metal members. The timing at which laser energy absorption is started in the metal members is reflected on the control of the application, and thus the molten state which is varied depending on the metal members to be welded can be made uniform. For example, even when the metal members such as copper whose reflectance is high are the targets to be welded, since it is possible to acquire a sufficient laser energy absorption time necessary for the metal members, it is possible to stably perform a welding operation without use of a large capacity laser oscillator and performing oxidization processing on the surface of the electrical conductors, with the result that it is possible to reduce the cost and the cycle time.

The present invention relates to a laser welding device including: a laser application portion (for example, the laser head 11 which will be described later) which applies the laser to metal members (for example, the electrical conductors 40 which will be described later) to be welded; a visible light detection portion (for example, the visible light sensor 13 which will be described later) which detects visible light emitted from vapor of the metal members produced by the application of the laser; and a control portion (for example, the laser control unit 20 which will be described later) which performs control of the application of the laser, where the control portion includes: a determination portion (for example, the determination portion 21 which will be described later) which compares a detection value of the visible light detection portion and a setting value so as to determine whether or not energy absorption is started in the metal members; and an application control portion (for example, the application control portion 22 which will be described later) which adjusts the control of the application of the laser based on timing at which energy absorption is determined to be started.

In this way, by the utilization of the visible light from the plume (metal vapor) in which the produced amount is increased as energy absorption proceeds, it is possible to accurately determine timing at which the absorption of the energy is started in the metal members. The timing at which laser energy absorption is started in the metal members is reflected on the control of the application, and thus the molten state which is varied depending on the metal members to be welded can be made uniform. For example, even when the metal members such as copper whose reflectance is high are the targets to be welded, since it is possible to acquire a sufficient laser energy absorption time necessary for the metal members, it is possible to stably perform a welding operation without use of a large capacity laser oscillator and performing oxidization processing on the surface of the electrical conductors, with the result that it is possible to reduce the cost and the cycle time.

According to the present invention, it is possible to provide a laser welding method and a laser welding device which can stably and efficiently supply a high-quality product by reducing a variation in laser energy absorption time.

### BRIEF DESCRIPTION OF THE DRAWINGS

FIG. 1 is a diagram schematically showing the unit configuration of a laser welding device according to an embodiment of the present invention;

FIG. 2 is a flowchart showing the flow of laser application control in the present embodiment;

FIG. 3A is a timing chart showing a relationship between a laser application time and an energy absorption time when in the present embodiment, timing at which energy absorption is started in electrical conductors is substantially the same as timing at which is previously assumed;

FIG. 3B is a timing chart showing a relationship between the laser application time and the energy absorption time when in the present embodiment, the start of the energy absorption time is earlier than the assumed timing;

FIG. 3C is a timing chart showing a relationship between the laser application time and the energy absorption time when in the present embodiment, the energy application time is later than the assumed completion time so as to be relatively lengthened;

FIG. 3D is a timing chart showing a relationship between the laser application time and the energy absorption time when in the present embodiment, the energy application time is later than the assumed completion time so as to be relatively shortened;

FIG. 4A is a timing chart showing a relationship between a laser application time and an energy absorption time when in a conventional example, timing at which energy absorption is started in electrical conductors is substantially the same as timing at which is previously assumed;

FIG. 4B is a timing chart showing a relationship between the laser application time and the energy absorption time when in the conventional example, the start of the energy absorption time is earlier than the assumed timing;

FIG. 4C is a timing chart showing a relationship between the laser application time and the energy absorption time when in the conventional example, the start of the energy absorption time is later than the assumed timing; and

FIG. 4D is a timing chart showing a relationship between the laser application time and the energy absorption time when in the conventional example, the start of the energy absorption time is earlier than in FIG. 4C but is later than the assumed timing.

### DETAILED DESCRIPTION OF THE INVENTION

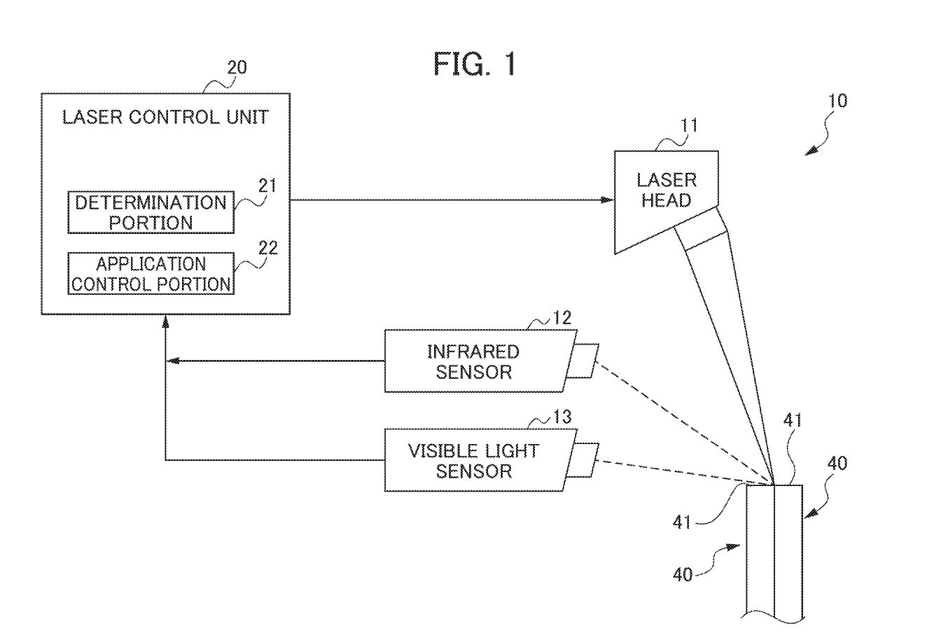

A preferred embodiment of the present invention will be described below with reference to drawings. FIG. 1 is a diagram schematically showing the unit configuration of a laser welding device 1 according to an embodiment of the present invention. The laser welding device 1 of the present embodiment performs a laser welding method of joining at least two electrical conductors 40 by laser welding.

As shown in FIG. 1, the laser welding device 10 includes a laser head 11 which applies a laser (laser light) to the electrical conductors 40, an infrared sensor (light detection portion) 12 which detects infrared light, a visible light sensor (light detection portion) 13 which detects visible light and a laser control unit 20 which controls individual portions of the laser welding device 10.

The laser head 11 is a laser application portion which applies an infrared laser to a work to be welded. The laser output from a laser oscillator (unillustrated) is applied through the laser head 11 to the work. The laser head 11 can be part of the laser oscillator. The laser head 11 of the present embodiment is formed such that the laser head 11 can be moved in a predetermined direction according to an application target.

In the present embodiment, a description will be given by using the two electrical conductors 40 made of copper as metal members (works) to be welded. The two electrical conductors 40 form, for example, the coil of a rotary electric machine, and is brought into an adjacent state through an arrangement step of inserting the electrical conductors 40 through the slots of a stator.

The two electrical conductors 40 are arranged so as to be adjacent to each other in a state where the tip ends 41 thereof are aligned, and a laser is applied in a direction which is inclined with respect to the joint surface of the electrical conductors 40. A plurality of electrical conductors 40 are arranged both in a radial direction and a circumferential direction, and when the welding of the two electrical conductors 40 is completed, the laser head 11 is moved (for example, is moved in the radial direction) to the subsequent target to be welded, and the welding operation is repeatedly performed. A method of arranging the two electrical conductors 40 can be changed as necessary according to conditions. For example, it is likely that the electrical conductors 40 are arranged so as to be adjacent to each other in a state where the positions of the tip ends 41 are displaced, and that the joining operation is performed.

The infrared sensor 12 is a reflected light detection portion which is arranged in such a position that the reflected light of the laser applied to the two electrical conductors 40 can be detected. The visible light sensor 13 is a visible light detection portion which is arranged in such a position that the light of plume (metal vapor) produced from the electrical conductors 40 can be detected. The infrared sensor 12 transmits the detected infrared light information to the laser control unit 20, and the visible light sensor 13 transmits the detected visible light information to the laser control unit 20.

The laser control unit 20 performs various types of control such as the application time of the laser, output adjustment and the change of an application position. In the present embodiment, the laser control unit 20 performs control on the application of the laser based on the infrared light information of the infrared sensor 12 and the visible light information of the visible light sensor 13. As the control performed by the laser control unit 20, various types of control system such as analog control, digital control and communication control can be used.

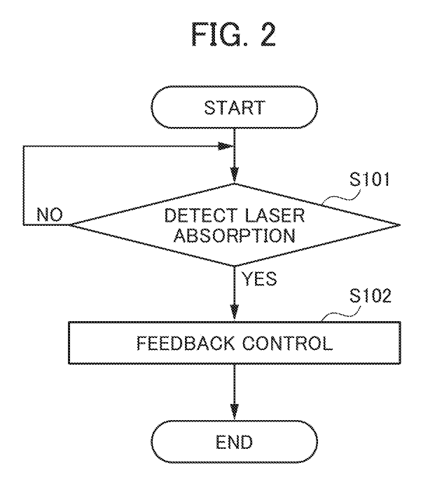

FIG. 2 is a flowchart showing the flow of the laser application control in the present embodiment. As shown in FIG. 2, when the laser application control is started, the laser control unit 20 applies the laser to the electrical conductors 40 which are the target to be applied, and detects, based on determination conditions, whether or not the absorption of the laser is started (step S101). In the present embodiment, the determination conditions are set based on the visible light information detected by the visible light sensor 13 and the infrared light information detected by the infrared sensor 12.

A first determination condition and a second determination condition with which a determination is made based on the detection value of the visible light sensor 13 will first be described.

As the first determination condition, a first detection threshold value (unit: V) and a first set number of times (unit: number of times) are previously set. The condition for determining that energy absorption is started is that the number of times the detection value of the visible light sensor 13 exceeds the first detection threshold value exceeds the first set number of times (for example, several tens of times). The reason why in the present embodiment, as the condition for determining that energy absorption is started, the condition in which the number of times exceeds the first set number of times (predetermined number of times) is set is that as energy absorption proceeds, a larger amount of plume (metal vapor) is produced.

As the second determination condition, a second detection threshold value (unit: V) which is set higher than the first detection threshold value and a second set number of times (unit: number of times) which is relatively set lower than the first set number of times are set. The condition for determining that energy absorption is started is that the number of times the detection value of the visible light sensor 13 exceeds the second detection threshold value exceeds the second set number of times (for example, once to several times).

The first determination condition is the condition for determining that energy absorption is started when the detection value of the visible light sensor 13 exceeds a relatively low reference value several tens of times. On the other hand, the second determination condition is the condition for determining that the absorption of the energy is started when the detection value of the visible light sensor 13 exceeds a relatively high reference value once or several times. The values of the first detection threshold value, the first set number of times, the second detection threshold value and the second set number of times are set empirically or theoretically according to facilities or the targets (the electrical conductors 40) to which the laser is applied.

A third determination condition based on the detection value of the infrared sensor 12 will then be described. In the third determination condition, the condition for determining that energy absorption is started is that the detection value of the infrared sensor 12 is equal to or less than a predetermined ratio (for example, several tens of percent) of a detection value at the start of the detection to a peak value. In this processing, since the peak value immediately after the output of the laser is zero, the detection is started after a predetermined time (for example, 1 m sec) has elapsed since the output.

In the present embodiment, when any one of the first determination condition, the second determination condition and the third determination condition is satisfied, energy absorption is determined to be started.

The determination conditions can be changed as necessary. For example, control may be performed in which when all of the first determination condition, the second determination condition and the third determination condition are satisfied, energy absorption is determined to be started, only one of the first determination condition, the second determination condition and the third determination condition may be set as the determination condition or a condition obtained by selecting two of the first determination condition, the second determination condition and the third determination condition and combining them may be set as the determination condition. Alternatively, a determination condition may be further added. As described above, the logic in which the start of energy absorption is determined based on the detection values of the visible light sensor 13 and infrared sensor 12 serving as the reflected light detection portion can be changed as necessary according to conditions.

When in the processing of S101, energy absorption is determined to be started, the feedback control of the laser application control is performed based on the timing at which energy absorption is started.

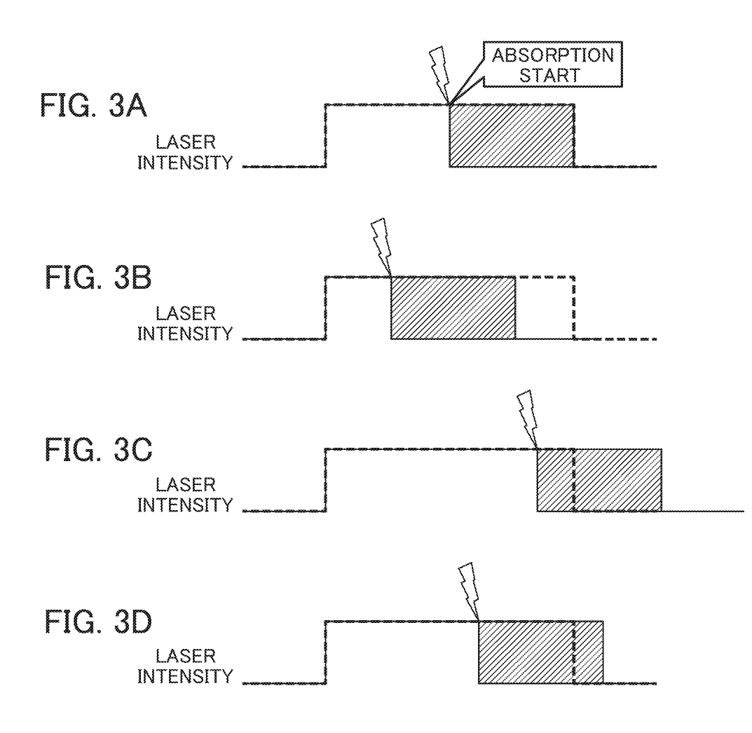

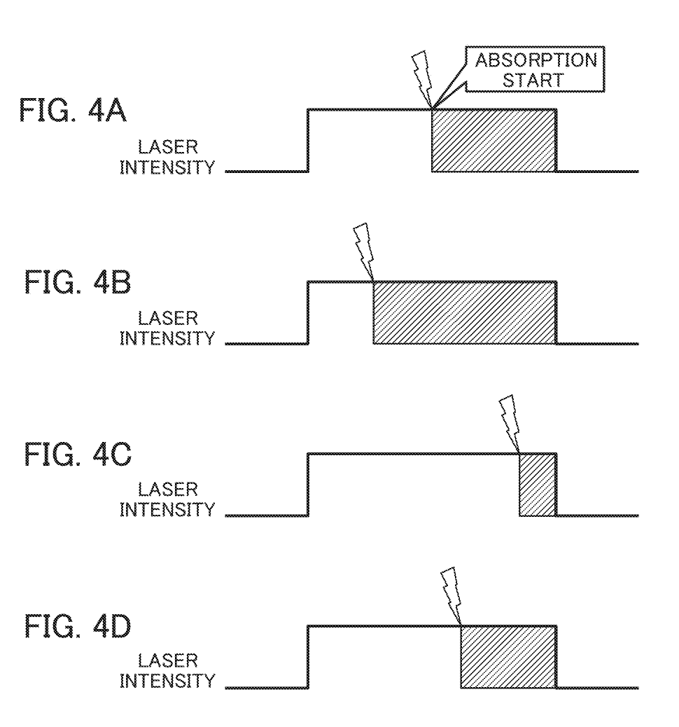

The feedback control in the present embodiment will be described. FIGS. 3A to 3D are timing charts showing a relationship between a laser application time and an energy absorption time in the present embodiment. FIGS. 3A, 3B, 3C and 3D show types of laser application control (laser application times) which are different depending on individual electrical conductors 40 serving as the metal members. Broken lines in FIGS. 3A to 3D indicate application times when the feedback control is not performed.

As shown in FIGS. 3A to 3D, the laser control unit 20 performs the feedback control for adjusting the application time of the laser in order to reduce variations in energy absorption start time which is different depending on the individual electrical conductors 40.

For example, in FIG. 3A, since timing at which energy absorption in the electrical conductors 40 is started is substantially the same as timing which is previously assumed, even when the application time is not adjusted, a time for a predetermined amount of energy absorption is acquired.

In FIG. 3B, the start of the energy absorption time is earlier than the assumed timing, and thus an adjustment for shortening the application time is performed. By contrast, in FIGS. 3C and 3D, the start of the energy absorption time is later than the assumed timing, and consequently, an adjustment for lengthening the application time is performed. In FIG. 3C, the energy application time is later than the assumed completion time so as to be relatively lengthened, and in FIG. 3D, the energy application time is later than the assumed completion time so as to be relatively shortened.

As described above, in the present embodiment, the control is performed in which after the absorption of the laser in the electrical conductors 40 is determined to be started, the application of the laser is continued for the predetermined time and in which thereafter the application of the laser is completed, with the result that the control is realized in which the amount of energy absorbed in the electrical conductors 40 is made uniform and in which thus the molten state is stabilized.

The laser welding method of the present embodiment described above is performed as follows. The laser welding method includes: a step of applying, with the laser head 11, a laser to a joint part of the electrical conductors 40 serving as the metal members to be welded, detecting, with the infrared sensor 12, the reflected light of the laser from the joint part produced by the application of the laser and detecting, with the visible light sensor 13, visible light emitted by the plume of the electrical conductors 40; and a step of comparing the detection values of the infrared sensor 12 and the visible light sensor 13 and setting values respectively so as to determine whether or not energy absorption is started in the electrical conductors 40 and adjusting the control of the application of the laser based on timing at which energy absorption is determined to be started.

The laser welding device 10 which performs the laser welding method described above includes: the laser head 11 serving as a laser application portion which applies the laser; the infrared sensor 12 serving as a reflected light detection portion which detects the reflected light of the laser applied from the laser head 11 to the electrical conductors 40 and the visible light sensor 13 serving as a visible light detection portion which detects the visible light emitted by the plume of the electrical conductors 40; and the laser control unit 20 serving as a control portion which performs the control of the application of the laser. The laser control unit 20 includes a determination portion 21 which compares the detection values of the infrared sensor 12 and the visible light sensor 13 and the setting values so as to determine whether or not energy absorption is started in the electrical conductors 40; and an application control portion 22 which adjusts the control of the application of the laser based on timing at which energy absorption is determined to be started.

In this way, the reflected light of the laser is detected, and thus by the utilization of the characteristic in which the electrical conductors 40 are changed from a reflection member to an absorption member absorbing the laser, it is possible to accurately determine timing at which the absorption of the energy of the laser is started in the electrical conductors 40. Moreover, by the utilization of the visible light from the plume (metal vapor) in which the produced amount is increased as the absorption of the energy proceeds, it is also possible to accurately determine timing at which the absorption of the energy is started in the electrical conductors 40. The timing at which laser energy absorption is started in the electrical conductors 40 is reflected on the control of the application, and thus the molten state which is varied depending on the electrical conductors 40 to be welded can be made uniform. Even when as in the present embodiment, the electrical conductors 40 such as copper whose reflectance is high are the target to be welded, since it is possible to acquire a sufficient laser energy absorption time necessary for metal members, it is possible to stably perform a welding operation with a small capacity laser oscillator without use of a large capacity laser oscillator and performing oxidization processing on the surface of the electrical conductors, with the result that it is possible to reduce the cost and the cycle time.

In the step of adjusting the control of the application in the present embodiment, the application of the laser is continued until a predetermined time has elapsed since energy absorption is determined to be started in the electrical conductors 40, and the application of the laser is completed after the predetermined time has elapsed.

In this way, it is possible to reduce variations in energy absorbed in the metal members, and thus it is possible to realize control for stabilizing the molten state with the simple processing for adjusting the application time.

Although the preferred embodiment of the present invention is described above, the present invention is not limited to the embodiment described above, and can be changed as necessary. For example, although in the embodiment discussed above, the example where the laser welding device includes both the infrared sensor 12 serving as the reflected light detection portion and the visible light sensor 13 serving as the visible light detection portion is described, it is possible to change it to a laser welding device which includes only the reflected light detection portion or to a laser welding device which includes only the visible light detection portion. In this case, based on the reflected light of the laser, whether or not energy absorption is started is determined or based on the visible light emitted from the metal vapor, whether or not energy absorption is started is determined. Whichever method is used, the timing at which energy absorption is started in the metal members is reflected on the control of the application, and thus it is possible to stably and efficiently the high-quality product.

Although in the embodiment discussed above, the example where the laser application portion applies the infrared laser is described, as long as the laser application portion can detect light, the laser application portion which applies laser other than the infrared laser can be applied. As the system of laser, various systems can be used such as fiber laser, CO₂ laser and semiconductor excitation laser.

Although in the embodiment described above, in the feedback control configuration, the laser application time is continued for the predetermined time with the timing at which energy absorption is started, the method of adjusting the laser application control can be changed as necessary. For example, a configuration may be adopted in which PDI control or computation is used to perform an adjustment (feedback control) for increasing or attenuating the application time or the laser output, and in which thus energy absorption is made uniform. For example, in order to make the absorbed amount of energy constant, control can also be performed where when the timing at which the energy is absorbed is early, the output is attenuated without the application time being adjusted whereas when the timing at which the energy is absorbed is late, the output is increased.

Although in the embodiment discussed above, the configuration is described in which the electrical conductors 40 made of copper are the metal members to be welded, the metal members to be welded are not limited to the configuration in the embodiment. The present invention can be applied to, for example, an operation of joining at least two or more metal members to be welded or metal members having at least two or more parts to be welded.

1. A laser welding method of joining metal members by laser welding, the laser welding method comprising:
a step of applying, with a laser application portion, a laser to a joint part of the metal members to be welded and detecting, with a light detection portion, light of the joint part produced by the application of the laser; and
a step of comparing a detection value of the light detection portion and a setting value so as to determine whether or not energy absorption is started in the metal members and adjusting control of the application of the laser based on timing at which the energy absorption is determined to be started.

2. The laser welding method according to claim 1, wherein the light detection portion detects reflected light of the laser.

3. The laser welding method according to claim 1, wherein the light detection portion detects visible light emitted from vapor of the metal members produced by the application of the laser.

4. The laser welding method according to claim 1, wherein in the step of adjusting the control of the application of the laser,
the application of the laser is continued until a predetermined time has elapsed since energy the absorption is determined to be started in the metal members, and the application of the laser is completed after the predetermined time has elapsed.

5. A laser welding device comprising: a laser application portion which applies a laser to metal members to be welded;
a reflected light detection portion which detects reflected light of the laser applied from the laser application portion to the metal members; and
a control portion which performs control of the application of the laser,
wherein the control portion includes:
a determination portion which compares a detection value of the reflected light detection portion and a setting value so as to determine whether or not energy absorption is started in the metal members; and
an application control portion which adjusts the control of the application of the laser based on timing at which the energy absorption is determined to be started.

6. A laser welding device comprising: a laser application portion which applies a laser to metal members to be welded;
a visible light detection portion which detects visible light emitted from vapor of the metal members produced by the application of the laser; and
a control portion which performs control of the application of the laser,
wherein the control portion includes:
a determination portion which compares a detection value of the visible light detection portion and a setting value so as to determine whether or not energy absorption is started in the metal members; and
an application control portion which adjusts the control of the application of the laser based on timing at which the energy absorption is determined to be started.

7. The laser welding method according to claim 2, wherein in the step of adjusting the control of the application of the laser,
the application of the laser is continued until a predetermined time has elapsed since energy the absorption is determined to be started in the metal members, and the application of the laser is completed after the predetermined time has elapsed.

8. The laser welding method according to claim 3, wherein in the step of adjusting the control of the application of the laser,
the application of the laser is continued until a predetermined time has elapsed since energy the absorption is determined to be started in the metal members, and the application of the laser is completed after the predetermined time has elapsed.
